(19) United States
(12) Patent Application Publication
(10) Pub. No.: US 2005/0079830 A1
(43) Pub. Date: Apr. 14, 2005

(54) Transceiver set for baby monitor

(76) Inventors: Gerald Serres Vives, Eloise (FR); Patrick De Wasseige, Moye (FR)

Correspondence Address: BROWDY AND NEIMARK, P.L.L.C.;624 NINTH STREET, NW, SUITE 300, WASHINGTON, DC, 20001-5303, US

(21) Appl. No.: 10/501,144

(22) PCT Filed: Jan. 9, 2003
(86) PCT No.: PCT/FR03/00056

(30) Foreign Application Priority Data
Jan. 14, 2002 (FR) 02/00381

(51) Int. Cl. H04B 1/38

(52) U.S. Cl. 455/90.3; 455/73

(57) ABSTRACT

The invention concerns a transceiver set for a baby monitor comprising a transmitter unit (1) and a receiver unit (2). The invention is characterized in that the transmitter unit (1) comprises at least a removable wall (4) providing access to the inside of a chamber (15) with greater dimensions than those of the receiver unit (2).

The present invention relates to a remote monitor, more particularly a set formed by a transmitter and at least one receiver constituting an audio baby monitor.

Audio monitors for babies or young children are known in the art, constituted on the one hand by a transmitter case placed in proximity to the baby and a receiver case placed in proximity to the parent or carried by the latter.

A transmitter case generally has a microphone and a transmitter device able to transmit a radio signal having a predetermined maximum range toward a receiver case having a receiving device that receives the radio signal and as a result triggers a visible, audible, tactile signal or a combination of these signals. The two cases, transmitter, respectively, receiver, also comprise electric power supply means.

A problem presented often by these appliances is their portability. Solutions have been provided by reducing the dimensions of the receiver which then becomes miniaturized, being able to be mounted on a bracelet or to be fixed by a fastener, or clip, to a belt or to a garment. Such a solution has been described in the document U.S. Pat. No. 5,512,880.

However, even with a portable receiver, there is always a question of the bulk and portability of the set. Thus, during a trip out of the home, for example when the child goes to child care or on vacation, the two appliances become cumbersome, and it is always difficult to take them along.

Another drawback is that the use of several appliances, for example, a monitor, a night light, a music box, etc., without the possibility of storage take up a great deal of space in a baby's room already cluttered by toys and various accessories.

There is known moreover from a related field, that of warning devices having electronic circuits able to emit audible warnings when a preestablished distance between the transmitter and the receiver has been exceeded, the document WO 00/74017 that describes a receiver case able to house one or several transmitter devices. In this document, the receiver case has been modified in a manner to create, at the interior of an open enclosure, a space permitting housing of one or several transmitting devices. This solution presents as a first disadvantage the fact of having a case based on unduly large dimensions, which proves to be bulky for a portable appliance, in this case the receiver. Moreover, the space permitting the transmitting devices to be housed is an open enclosure that does not ensure a good protection from the outside environment, nor security during transport.

The goal of the invention is to overcome the above-cited drawbacks and to provide a baby monitor that is of reduced bulk and is easily transportable during travel outside.

Another goal of the invention is to provide a closed storage space for the components of the baby monitor being able to make the transmitter and receiver set easily transportable, while providing a portable receiver case that is particularly compact.

Another goal of the invention is a baby monitor integrating several functions in the same case, all while being reliable in operation and easy to mass produce at low fabrication cost.

A supplementary goal of the invention is to provide storage for a transceiver set of a baby monitor, of small bulk, all while being able to facilitate transport of the set in complete safety, without risk of damaging its components.

These goals are achieved with a transceiver set for a baby monitor, having a transmitter case and a receiver case, by the fact that the transmitter case has at least one removable wall permitting access to the interior of an enclosure having dimensions greater than those of the receiver case.

A transmitter case is understood to be an appliance having a transmitter function comprising thus, at the interior of a case, a microphone, a transmitting antenna, electric energy supply means, an electronic circuit effecting management of its operation, as well as a control interface. In the same manner, a receiver case is understood to be an appliance having a receiving function, having, at the interior of a case, a receiving antenna, a speaker, electric supply means, an electronic circuit and a control interface and, outside of the case, a means for attachment or for support of the case.

According to the invention, the enclosure of the transmitter case has dimensions greater that those of the receiver case, i.e. the dimensions of said enclosure are sufficient to accept the receiver case which can be stored at the interior of the transmitter case. This permits the receiver case, which is portable, to have a compact construction and to be stored at the interior of the transmitter case which, itself, is normally placed on a support, close to the baby.

A removable wall is understood to be a wall that can be displaced relative to the transmitter case, either while remaining connected to this latter, for example by means of hinges or a guide rail, or by being completely removed. In the two cases, said wall should free an opening in the transmitter case, which opening has dimensions permitting insertion of the receiver case into the transmitter case.

The receiver case can thus be stored at the interior of the transmitter case. This permits having the two appliances in a single one when they are not in use, all while being able to separate them for use. Thus, the bulk is greatly reduced while obtaining additional space during transport and storage of the two appliances. In addition, the receiver case is protected by the exterior of the transmitter case during their transport.

Advantageously, the base of said enclosure has a formation provided to cooperate with the lower face of the receiver case or one of the inner walls of said enclosure has means for hanging the receiver case.

Thus, in a variant, the receiver case can be arranged at the interior of the transmitter case enclosure by simply being placed on the base of the enclosure. The surface of the base of the enclosure can be flat or warped (or curved), the surface of the lower face of the receiver case can equally be flat or warped with a form complementary to that of the base of the enclosure. This assures stability and a good positioning of the receiver case at the interior of said enclosure. A supplementary lateral support zone can be envisioned in said enclosure, a zone on which comes to bear one of the lateral faces of the receiver case, which renders even more stable the set of the two during transport.

In another variant, the receiver case can be fixed to one of the lateral walls of the transmitter case during storage at the interior of this latter. For this, the lateral wall of the case has a rib forming a hook and the transmitter case has a clip in a corresponding form that comes to be positioned in said hook. In a supplementary variant, one can provide for fastening the receiver case to an intermediate support provided with means for coupling (or hanging) close to a rib of the wall of the transmitter case.

Preferably, the ratio between the volume of said enclosure and of the receiver case is comprised between 1.3 and 2.5.

An optimum ratio has been determined for the volumes during tests performed, which permits having sufficient space to insert the receiver case at the interior of the transmitter case without for that matter increasing the volume of the transmitter case in an excessive manner. These values are applied to the situation where the monitor has a transmitter that functions with a single receiver. In the situation where there are several receivers, the enclosure of the transmitter case will be dimensioned in order to be able to insert all of the receivers at the interior.

Usefully, the transmitter case has a pedestal covered by an exterior shell, said enclosure being delimited between the exterior shell and said pedestal.

A pedestal is understood to be a part, preferably enclosed, constituting the base of the transmitting case, the upper part of the pedestal being able to serve as a support for the receiver case. The exterior shell has the form of a bell or a dome which can surround the pedestal at its upper and lateral sides or which simply comes to rest on the upper face of the pedestal while thus defining a closed enclosure with this latter.

Advantageously, said pedestal encloses means forming a microphone, supply means and an electronic circuit for management of the operation.

It is useful to group all of these components within a closed space first of all for reasons of protection of sensitive components and then to save space at the interior of the transmitter.

Preferably, said removable wall has elastic coupling means provided to cooperate with retaining means of the exterior shell.

This permits the removable wall and the exterior shell of the transmitter case to be fixed together, while facilitating their unlocking which can be achieved, for example, by using a finger traversing the entire thickness of the exterior shell and coming to bear on an elastic tongue of the removable wall. Conversely, the coupling means can belong to the exterior shell of the transmitter case and the retaining means to the removable wall.

Advantageously, said exterior shell is made of a material that is transparent to light over at least a part of its surface.

This permits, on the one hand, the possibility for the user to see the interior of the case and, on the other hand, assures a transmitter case with a supplementary function, that of a night light. The exterior shell can be entirely, over all of its surface, or only in part made of a material that is transparent or semitransparent to light. This wall can equally be covered with designs or figures.

Preferably, the transmitter case has a bulb connected to the supply means and to the electronic circuit of this latter.

Thus, in an advantageous manner according to the invention, the storage space at the interior of the transmitter housing is arranged in an illuminated compartment which permits one to see if the receiver case is found therein. In placing the transmitter case in the night light mode, one can observe more easily through the transparent window whether the receiver has been stored at the interior of the transmitter and permits rapid retrieval of a receiver case which will have been placed absentmindedly and forgotten at the interior of the storage space of the transmitter case.

Furthermore, in the absence of a receiver case, the transmitter case can be transformed into a night light, which has the advantage of furnishing an appliance having multiple functions. The bulb can be connected the electric circuit of the transmitter or it can be powered by its own circuit.

Advantageously, the internal wall of said exterior shell is covered with a light reflecting material over at least a part of its inner surface facing the bulb.

This permits amplification of the brightness of the night light, while using a low power bulb. Preferably, the internal wall covered with reflecting material faces the light transparent part of the exterior shell.

Preferably, the receiver case is mounted on a bracelet or it has a clip for attachment to a piece of clothing.

This supposes a receiver housing of small dimensions which is easily portable by the person assuring monitoring of the baby, all while permitting at the same time reduction of the dimensions of the enclosure of the transmitter case. Advantageously, said attachment clip can be mounted on a bracelet furnished with an attachment support for the clip.

The invention will be better understood from a study of an embodiment given by way of non-limiting example and illustrated in the attached figures in which:

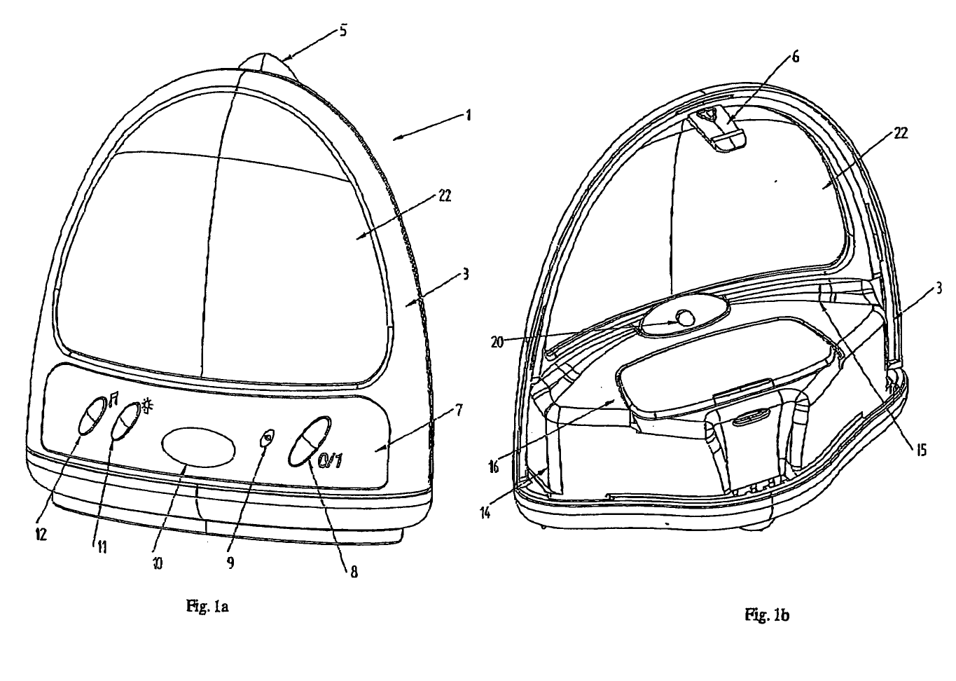

FIG. 1a shows a perspective view of the transmitter case seen from the front;

FIG. 1b shows a perspective view of the interior of the transmitter case seen from the rear, a part of its exterior shell being removed;

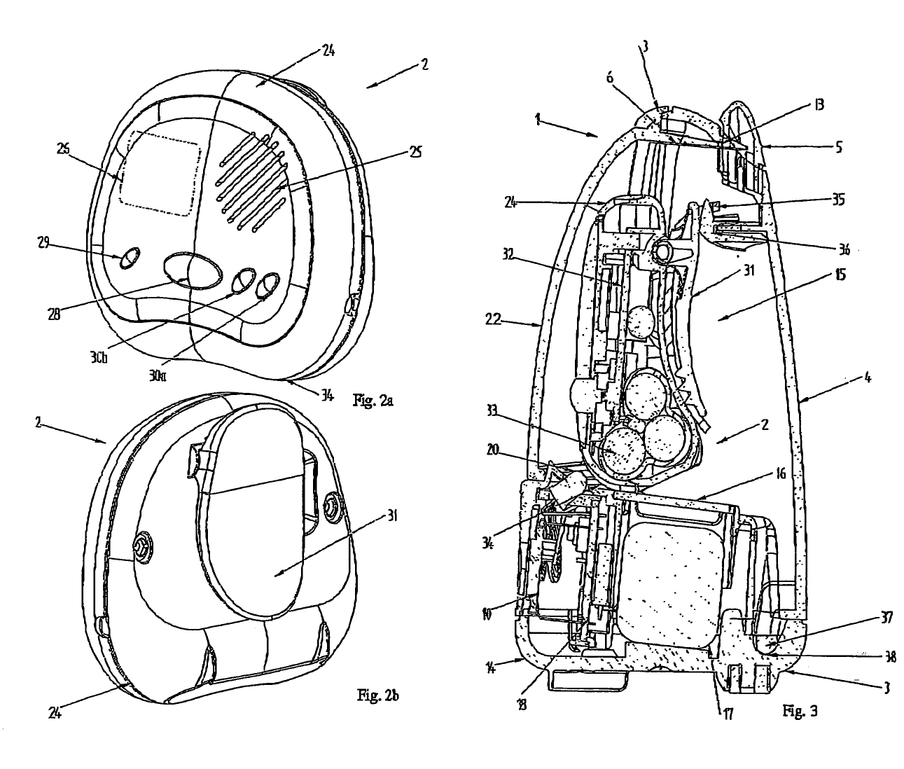

FIG. 2a shows a perspective view of the receiver case seen from the front;

FIG. 2b shows a perspective view of the receiver case seen from the rear;

FIG. 3 is a view in axial cross section of the transceiver set of the invention, the receiver case being mounted at the interior of the transmitter case.

Referring to the drawings, on FIG. 1a representing a view of the transmitter case 1, there will be noted an exterior shell 3 having a front wall 22 that is transparent to light, an antenna 5 and a control interface 7. On control interface 7 are found: an on/off switch 8 having a two-color diode indicating the operating state of the appliance, a microphone 9, an LCD display 10 that indicates ambient temperature, an on/off switch 11 of a night light, as well as an on/off switch 12 of a music box.

According to the invention, transmitter case 1 has a removable wall 4, seen more clearly in FIG. 3, which constitutes the rear wall of exterior shell 3. In a variant, it can equally be the front wall or any other part capable of being removably mounted with respect to the rest of the case in order to permit access to the interior of transmitter case 1. Removable wall 4 presents, at its lower part, guide feet 37 that are inserted into cavities 38 of corresponding form of exterior shell 3, and, at the upper part, a retaining cavity 13 for a tongue 6 belonging to exterior shell 3, tongue 6 which comes to be inserted into cavity 13 of removable wall 4 by locking it against exterior shell 3.

FIG. 1b shows the interior of transmitter case 1, the rear part or removable wall 4 of exterior shell 3 being removed. Thus, one notes in the lower part of transmitter case 1, a pedestal 14 defining with exterior shell 3 an enclosure 15. Pedestal 14 is made in the form of a closed case comprising most of the components of transmitter case 1. Exterior shell 3 is in the form of a dome and surrounds pedestal 14 on its lateral sides.

As is more clearly visible in FIG. 3, at the interior of the pedestal 14 there is found a battery case that supplies energy to an electronic circuit 18. Electronic circuit 18 has a microprocessor assuring electronic management of the operation of the appliance, including transformation of the signal from microphone 9 into a radio signal at a predetermined frequency that is transmitted to the receiver through antenna 5.

A bulb, or lamp, 20 is arranged at the front and at the upper part of pedestal 14, projecting toward the exterior of this latter and being oriented toward the inner face of removable wall 4 of exterior shell 3. Bulb 20 is connected to electronic circuit 18 assuring its electric supply and its operation. In order to assure a good reflection of the light furnished by bulb 20 at the interior of enclosure 15, the inner face of removable wall 4 is made of a polished metallic material of a metalized plastic material having a very precise finish.

Receiver case 2 of the invention is visible in FIG. 2a, particularly the front face of its case 24 which comprises: a speaker 25, a display 26 of the liquid crystal type, an on/off switch 28, a button 29 to start and stop the vibrator and two sound volume regulating buttons: one 30a to increase the volume and the other 30b to reduce the volume of speaker 25. The dimensions of the receiver case are reduced in a manner such that the receiver case can be carried attached to a garment or mounted on a bracelet. For this, case 24 has on its rear face a fastening clip 31, which is visible in FIG. 2b. By way of example, such a receiver case can have the following maximum dimensions: 40 mm×40 mm×15 mm.

In a variant, fastening clip 31 can be mounted on a flat or slightly curved support of a bracelet. This support is provided with a slot permitting insertion of the clip which then becomes fixed to the bracelet and can be carried on the wrist. In an advantageous manner, the same slot of the bracelet support can serve as a fastening hook of receiver case 2 at the interior of transmitter case 1, as shown in FIG. 3.

The receiver case contains power supply batteries 33, visible in FIG. 3, an integrated antenna not visible in the figures, a vibrator, as well as a microprocessor electronic circuit 32 assuring management of its operation, which includes reception of the signal emitted by antenna 5 of the transmitter and transformation of this signal into an audible signal from speaker 25. On the screen of display 26 are shown: the intensity of the signal received by the receiver, the regulation of the sound level, the number of the receiving channel, the charge state of the batteries, the state of the vibrator, etc.

In operation, transmitter case 1 is placed in the baby's room, in proximity thereto. The appliance is connected to a power outlet and it is turned on by the parent by acting on switch 10. Receiver case 2, after being turned on by switch 28, is attached to a piece of clothing of the parent who can then go away from the baby, while remaining in contact with him. The baby's cries are transmitted by transmitter case 1 to receiver case 2 and are then heard by the parent who can then react. Transmitter case 1 can equally function as a night light, or as a music box by activating the respective functions in transmitter case 1.

When the monitor, having transmitter case 1 and receiver case 2, is turned off for reasons of storage or to carry it along during travel out of the residence, the parent can insert receiver case 2 in the interior of transmitter case 1, as shown in FIG. 3. To gain access to the interior of enclosure 15 of transmitter case 1, the parent withdraws removable wall 4 by pressing on coupling tongue 6 of exterior shell 3 and by separating it from orifice 13, having a corresponding form, of wall 4. Then, the parent places receiver case 2 into enclosure 15, with lower face 34 of its case 24 placed on base 16 of enclosure 15 or, in a variant shown in FIG. 3, by hooking support 35 of receiver case 2 onto rib 36 of removable wall 4. Once the receiver case is in place, the parent closes enclosure 15 by putting removable wall back in place.

The envelop pieces, shells or cases, of the transmitter and of the receiver are preferably made of a thermoplastic material, for example ABS, which presents a good resistance to shocks and permits transport of the transceiver set in complete safety.

Other variants and embodiments of the invention can be envisioned without departing from the framework of its claims.

Thus, one can imagine that the pedestal of the transmitter case is furnished with a transformer having electric supply contacts that come to be connected with power supply pins of the receiver case, thus permitting recharging the batteries of the receiver case when it is placed at the interior of the transmitter case.

1. Transceiver set for a baby monitor, having a transmitter case (1) and a receiver case (2), characterized in that the transmitter case (1) has at least one removable wall (4) permitting access to the interior of an enclosure (15) having dimensions greater than those of the receiver case (2).

2. Transceiver set according to claim 1, characterized in that the base (16) of said enclosure (15) has a formation provided to cooperate with the lower face (34) of the receiver case (2) or in that one of the inner walls of said enclosure (15) has means for hanging the receiver case (2).

3. Transceiver set according to claim 1, characterized in that the ratio between the volume of said enclosure (15) and of the receiver case (2) is comprised between 1.3 and 2.5.

4. Transceiver set according to claim 1, characterized in that the transmitter case has a pedestal (14) covered by an exterior shell (3), said enclosure (15) being delimited between the exterior shell (3) and said pedestal (14).

5. Transceiver set according to claim 4, characterized in that said pedestal (14) encloses means forming a microphone (9), supply means and an electronic circuit (18) for management of the operation.

6. Transceiver set according to claim 4, characterized in that said removable wall (4) has elastic coupling means provided to cooperate with retaining means of the exterior shell (3).

7. Transceiver set according to claim 1, characterized in that the transmitter case (1) has a bulb (20) connected to the supply means and to the electronic circuit of this latter.

8. Transceiver set according to claim 4, characterized in that said exterior shell (3) is made of a material that is transparent to light over at least a part of its surface.

9. Transceiver set according to claim 4, characterized in that the internal wall of said exterior shell (3) is covered with a light reflecting material over at least a part of its inner surface facing the bulb.

10. Transceiver set according to claim 1, characterized in that the receiver case (2) is mounted on a bracelet or it has a clip (31) for attachment to a piece of clothing.

11. Transceiver set according to claim 5, characterized in that the internal wall of said exterior shell (3) is covered with a light reflecting material over at least a part of its inner surface facing the bulb.

12. Transceiver set according to claim 6, characterized in that the internal wall of said exterior shell (3) is covered with a light reflecting material over at least a part of its inner surface facing the bulb.

13. Transceiver according to claim 7 characterized in that the transmitter case has a pedestal (14) covered by an exterior shell (3), said enclosure (15) being delimited between the exterior shell (3) and said pedestal (14).

14. Transceiver set according to claim 13, characterized in that the internal wall of said exterior shell (3) is covered with a light reflecting material over at least a part of its inner surface facing the bulb.

15. Transceiver set according to claim 8, characterized in that the internal wall of said exterior shell (3) is covered with a light reflecting material over at least a part of its inner surface facing the bulb.
